(19) United States
(12) Patent Application Publication
(10) Pub. No.: US 2013/0144920 A1
(43) Pub. Date: Jun. 6, 2013

(54) CREATING A CONFIGURATION FILE TEMPLATE

(71) Applicant: Michael Boyd, Raleigh, NC (US)

(72) Inventor: Michael Boyd, Raleigh, NC (US)

(21) Appl. No.: 13/816,980

(22) PCT Filed: Oct. 13, 2010
(86) PCT No.: PCT/US10/52440

§ 371 Date: Feb. 14, 2013

(51) Int. Cl. G06F 17/30

(52) U.S. Cl. CPC G06F 17/30115
USPC 707/805

(57) ABSTRACT

Methods and systems are provided for creating a configuration file template. One method for creating a configuration file template includes presenting 568 a base configuration file stored in memory in a window of a first pane 220, selecting 572 a portion of the base configuration file that indicates a syntax element 236, and defining 576 one 244 or more parameters 230/232/234 of the selected syntax element. The method also includes defining the one or more parameters upon receiving a value 244 or choosing from an already defined list of values 242, at least one of the parameters including a defined descriptor 240 for the selected syntax element, and presenting 576 the user defined descriptors 246/248 associated with the selected syntax element 236 or group of elements 227/228 in a second pane 222.

### BACKGROUND

Configuration files are used for running many types of computer applications. Writing a configuration file from a blank sheet of paper or empty screen of a user interface can be a time consuming and laborious process, in addition to utilizing a specific skill set by the author. One practice used to reduce the burden of starting configuration files from scratch is to look at an existing configuration file and try to adopt aspects of it and other existing configuration files to create new configuration files. Doing so can present a different set of challenges for the author that may also be time consuming and laborious. For example, in modeling elements of an existing configuration file, an author may have to parse through the existing file, and copy elements of the existing file to modify into a new file. In addition, the author will need to write new elements.

Care has to be taken to ensure the configuration file created has the proper syntax. When elements of the existing configuration file are combined with the newly written elements, the author must take time to understand and establish proper syntax so that the resulting file configuration is operational. If each of the code elements in a configuration file does not have the proper syntax, the file may not run properly. Further, because of the complexity of many configuration files, even with careful attention, the lack of operability may not be discovered prior to attempting to run the file in a production environment. Once discovered, even more time and resources may have to be spent by an author to go back to the configuration file and troubleshoot the syntax.

### BRIEF DESCRIPTION OF THE DRAWINGS

FIG. 1 illustrates a system for creating a configuration file template according to a number of embodiments.

FIG. 2A is a screen shot illustrating an embodiment of a user interface for creating a configuration file template according to the present disclosure.

FIG. 2B is a screen shot illustrating an embodiment of a user interface for creating a configuration file template according to the present disclosure

FIG. 3 is a drawing illustrating an embodiment of a configuration file template.

FIG. 4 is a drawing illustrating an embodiment of using a configuration file template.

FIG. 5 is a block diagram illustrating a method for creating a configuration file template according to a number of embodiments.

FIG. 6 illustrates a block diagram of an example of a computer readable medium (CRM) in communication with processing.

### DETAILED DESCRIPTION

Methods and systems are provided for creating a configuration file template. For example, one method for creating a configuration file template includes presenting a base configuration file stored in memory in a window of a first pane, selecting a portion of the base configuration file that indicates a syntax element, and defining one or more parameters of the selected syntax element. The method also includes defining the one or more parameters upon receiving a value or choosing from an already defined list of values, at least one of the parameters including a defined descriptor for the selected syntax element, and presenting the user defined descriptors associated with the selected syntax element or group of elements in a second pane.

In the present disclosure, reference is made to the accompanying drawings that form a part hereof, and in which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized and that process, electrical, and/or structural changes may be made without departing from the scope of the present disclosure.

The figures herein follow a numbering convention in which the first digit or digits correspond to the drawing figure number and the remaining digits identify an element in the drawing. Similar elements between different figures may be identified by the use of similar digits.

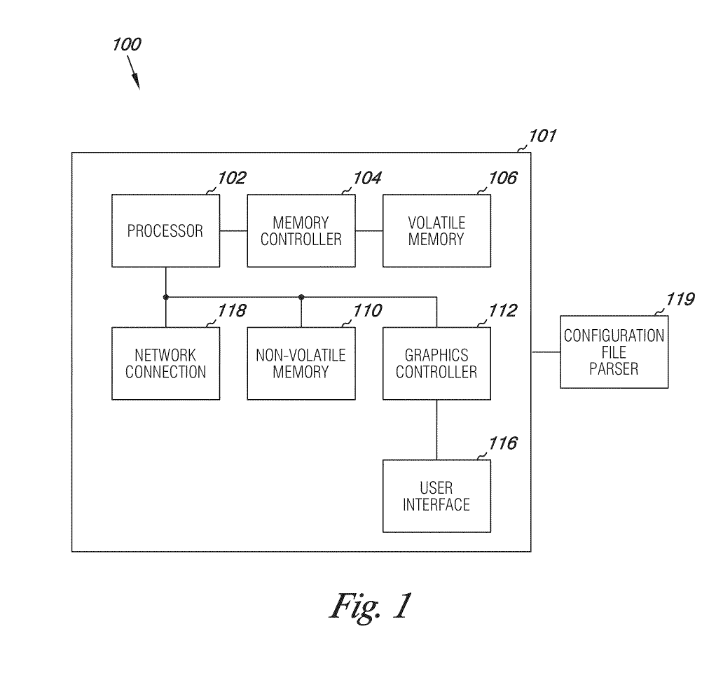

FIG. 1 illustrates a block diagram of an example of a system 100 for creating a configuration file template. The configuration file template system 101 can include processor resources 102 and memory resources (e.g., volatile memory 106 and/or non-volatile memory 110) for executing instructions stored in a non-transitory computer-readable medium. Actions described herein can be performed by computer executable instructions stored in the memory resources and executed by the processor resources. In addition, actions can be implemented using hardware, including an application specific integrated circuit (ASIC). Embodiments, however, are not so limited to software and logic.

The processor resources 102 can control the overall operation of the system 101. The processor resources 102 can be connected to a memory controller 104, which can read and/or write data from and/or to volatile memory 106 and/or non-volatile memory 110 (e.g., RAM, flash).

The processor resources 102 can provide for communication between the processor resources 102 and other portions of the system 100 including a network connection 118. The non-volatile memory 110 (e.g., hard disk, SSD, etc.) can provide persistent data storage for the system. The graphics controller can connect to a user interface 116 based on activities performed by the system. The configuration file template system allows the user to visualize the configuration syntax that will be used by the configuration file parser 119.

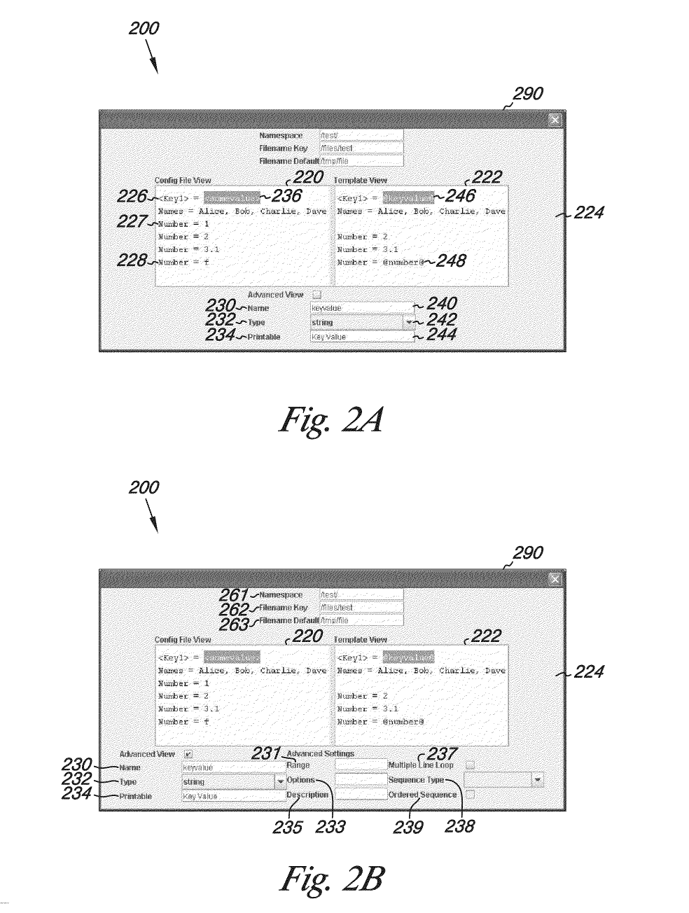

FIG. 2A is a screen shot illustrating an embodiment of a user interface for creating a configuration file template. The user interface 200 presents in an application window 290 a first read-only pane 220 with the base configuration file view and a second read-only pane 222 with the configuration template view and a syntax editing pane 224 containing parameters (e.g. Name 230, Type 232, and Printable 234) that can be entered or edited by the user. These parameters are examples of suitable types of parameters that could be changed and other parameters could be identified by those skilled in the art.

In the example structure of FIG. 2A, the first pane 220 displays syntax elements of a base configuration file, including, for example, elements 226, 227, and 228. The user edits the parameters (e.g. Name 230, Type 232, and Printable 234) in the syntax editing pane 224 and based on the information entered for the parameters, defined descriptors replace the syntax element or elements in the second pane 222. An example of a defined descriptor in the second pane 222 is “@keyvalue@” 246. In various system and method examples the descriptors can be user defined descriptors and can, for example, be defined through use of input from a user via a user interface associated with a computing device. The user defined descriptor can also be defined by logic.

For example, the first pane 220 displays the value <somevalue> 236 for base configuration file element <Key1> 226. In some implementations, after the user selects <somevalue> 236, then <somevalue> 236 can be illustrated highlighted. This can be beneficial in identifying to the user that it is this particular value that is being manipulated.

When the user edits the parameter Name 232 with the value “keyvalue” 240, then the second pane 222 displays the descriptor as “@keyvalue@” 246 in the configuration file template. Every occurrence of <somevalue> 236 in the first pane 220 can be replaced by the descriptor “@keyvalue@” 246 in the configuration file template. In this way, the template can be customized more quickly than through manual entry of code by the user via a user interface.

Multiple syntax elements in the first pane 220 can be represented by one descriptor in the second pane 222 depending on the parameters defined by the user. For example, value “@number@” 248 in the second pane 222 can be used to represent syntax element 227 and syntax element 228 from the first pane 222 of the base configuration file. In some examples, the system can be designed such that every occurrence of repeating syntax elements in the first read-only pane can then be replaced by the descriptor for the associated syntax elements in the second-read only pane. This can be beneficial in some instances and the visual representation of the associated syntax elements can allow the user to model how a configuration file parser engine will identify the associated elements, and as such, the user can visually validate whether associated the elements have the proper syntax. From the parameters entered by the user in the syntax editing pane, the configuration file template provides syntax in enough detail that the configuration file parser can generate a logical structure that is able to parse the configuration file. In another example, the configuration file parser uses the description of the values from the user selection and definition of syntax elements to generate a valid configuration file from the configuration file template.

In some method embodiments, the method can be produced by providing a user interface that presents three panes in an application window, a first read-only pane presents a base configuration file, allowing the user to select a portion of the base configuration file. In the same application window a syntax editing pane allows the user to define one or more of parameters of the selected portion of the base configuration file, and define a descriptor. In the same application window a second read-only pane replaces the portion of the base configuration file selected with defined descriptor associated with the selected portion. In some embodiments, when the user selects a user defined descriptor in the second read-only pane, the user defined descriptor can be highlighted and the portion of the base configuration file associated with the user defined descriptor can be highlighted in the same way in the first read-only pane. In this manner, the user can visually ascertain the relationship between the items in the left pane and the right pane which can be beneficial in some instances.

This method of creating a configuration file template can, for example, present the user with a visual representation of how the configuration file parser will associate elements with the given parameters. This may also alleviate the burden of the author having to create a configuration file template by memory or by merely combining elements of an existing file with new elements and making errors in doing so, which may occur in some situations.

Errors can occur in creating new configuration files, for example, because of the complexity of file syntax or use of multiple languages or a combination thereof. Those errors may go unnoticed until the configuration file is run in production. In such situations, as discussed above, troubleshooting such errors can be time-consuming and costly. By being able to visually identify potential problems when modeling the syntax of a configuration file, in advance of running the configuration file in a production environment, resource expenditure can be reduced.

Creating a configuration file template can begin, for example, by the user selecting a syntax element or group of elements in the first read-only pane or the second read only pane. In some embodiments, the same base configuration file can be provided to both the first read-only pane and the second read-only pane. In this manner, the user can quickly begin customizing items for the new configuration file. The user can choose to create a complete configuration file template from a base configuration file, or a partial configuration file template from a desired portion of the base configuration file. In some arrangements, partial templates can be used to model one element of a configuration file. The user can verify the configuration template element has the proper syntax. In some examples, the user can combine multiple partial configuration file templates to create the desired configuration file template.

Aspects of the system and method for creating a configuration file template make the method easy to perform for many types of users. Examples include system administrators, Windows administrators, Linux administrators, network administrations and others.

In some methods, the user interface can allow the user to select a user defined descriptor in the configuration file template (e.g. the second read-only pane), and see highlighted text in the base configuration file (e.g. the first read-only pane). In some arrangements, the user interface can allow the user to select a syntax element in the base configuration file and see highlighted text in the configuration file template. Highlighting the defined descriptor in the second read-only pane in the same way as the portion of the base configuration file which presents the associated syntax can create an easy to understand visual relationship for comparison and validation of accuracy. The visual representation of the associated syntax elements can allow the user to model how a configuration file parser engine will identify a value for all of the associated syntax elements.

Accordingly, highlighting refers one mode of making the text visually distinct from the surrounding text. Highlighting can take the form of underling, making the text bold, changing the font type from the surrounding text, use of distinguishing marks such as an asterisk, changing the font color from the surrounding text, or other means of making text visually distinct that are known to those skilled in the art.

In arrangements where the user defines the descriptors for the elements of the configuration file template that represent the portions of the configuration file that has been parameterized, the user defining makes the configuration file template easy for the user to read, without having to sift through all of the code of a base configuration file or a configuration template, among other benefits.

In such arrangements, a user can select an element to edit from the first read-only pane or the second read-only pane. A user can, for example, select an element through a user interface and can employ one of many user selectability mechanisms to make that selection. User selectability mechanisms include any mechanism that allows a user to make a selection. For example, suitable mechanisms include: point and click selection, keystroke, and/or touch screen navigation, among others.

In some implementations, a syntax element or associated group of syntax elements represents a value that the configuration file parser can recognize and use when generating a valid configuration file. By defining parameters in the syntax editing pane, the user can define the string of characters used to represent the value in the configuration file template. This can also allow the configuration file parser to recognize the string of characters as a value used in generating a configuration file.

In some examples, the user selects the user defined descriptor for the syntax element or associated group of syntax elements. The user defined descriptor may describe the element or group of elements. This can be beneficial, for example, as the configuration file template can be easy to read by the user as they have defined the values and selected the defined descriptor to identify a group of elements. The user defined descriptor may represent a value that the configuration file parser can use to parse the configuration file template to generate a configuration file.

In some arrangements, the user defined descriptors in the second read-only pane that are presented with an “@” on either side of the descriptor are created when a user inputs values for selected parameters. As discussed above, other ways of identifying/highlighting items such as user-defined values can be used, including other symbols or specified font. The user defined descriptor may begin and end with the same text character to create a visual cue to the user. The text character may also server as an identifier to the configuration file parser to assist the parser in identifying values for generating a valid configuration file from the configuration file template.

In some arrangements defining one or more parameters may include selecting a portion of a key property of the configuration file to represent the syntax element or group of elements in the configuration file template. Key-value pairs associate a value to a key property in a configuration file. A subset of the key-value pair may be the user defined descriptor entered in the syntax editing pane as a parameter. This can be beneficial, for example to allow the user to easily identify the parameter in the configuration file template. Similarly in some arrangements this can allow the configuration file parser to more easily identify value for generating a valid configuration file.

FIG. 2B is a screen shot illustrating another embodiment of a user interface for creating a configuration file template according to the present disclosure. The user interface 200 presents in an application window 390 a first read-only pane 220 with the base configuration file view and a second read-only pane 222 with the configuration template view and a syntax editing pane 324 containing parameters (e.g. Name 230, Type 232, and Printable 234) that can be entered or edited by the user. In some arrangements, after selecting a portion of the base configuration file indicating a syntax element or a group of syntax elements, the user can define one or more desired parameters in the syntax editing pane.

The user can, for example, define the parameters by entering a value or choosing from an already defined list of values. Parameters can specify the characteristics of the syntax element or group of elements the user is associating together. This can be beneficial, for example, as these characteristics can be used by related components in the downstream system.

In some implementations, some parameters may help a configuration file parser identify a value being parameterized. Some examples of parameters that can be used include Type 232, Range 231, Options 233, Multiple Line Loop 237, Sequence Type 238, Ordered Sequence 239. The element or group of elements can, for example, be associated together for the purpose of allowing the configuration file parser to identify the value desired by the user.

In various implementations, some parameters may be used by a configuration file management software when displaying value placeholders. Some examples include, Printable 234 and Description 235 parameters. In addition, parameters can be utilized to specify the some characteristics of the entire template, not just the syntax element or group of elements the user is associating together. For instance, some examples include: Namespace 361, Filename Key 262, and Filename Default 263 parameters.

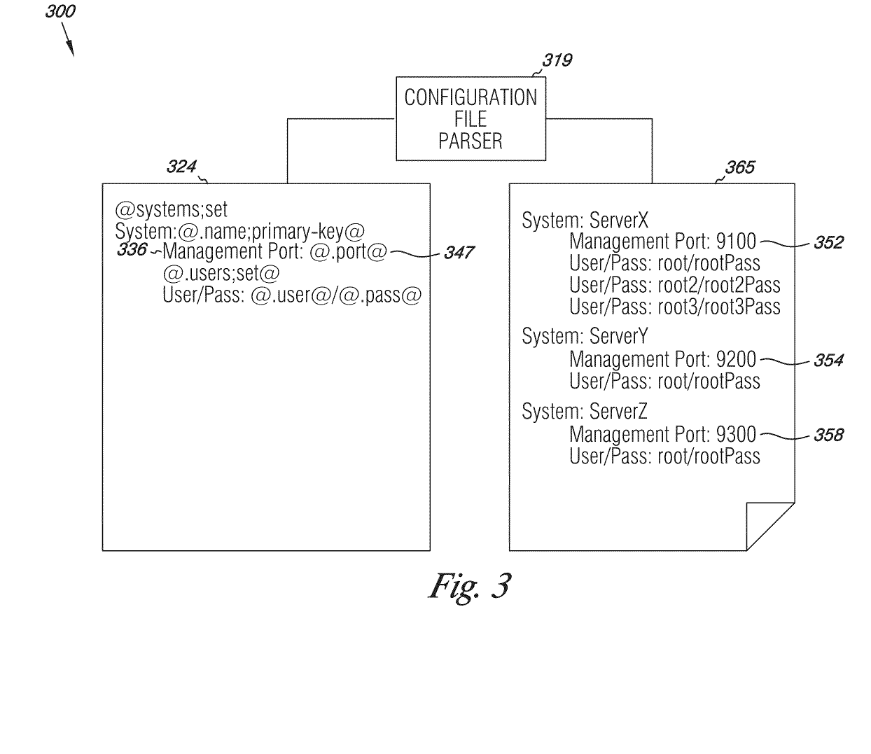

FIG. 3 is a drawing illustrating an embodiment of a configuration file template. FIG. 3 illustrates a drawing of a method 300 of using the configuration file template 324 to create a configuration file 365. In an example, the configuration template element ‘Management port’ 336 has the defined descriptor @.port@ 347 that the configuration file parser 319 can identify and use to generate the resulting representation of a configuration file 365. Using the information entered for the parameters of the defined descriptor 347 in the configuration file template 324, the configuration file presents ‘Management port’ 336 with representative values ‘9100’ 352, ‘9200’ 354, ‘9300’ 358.

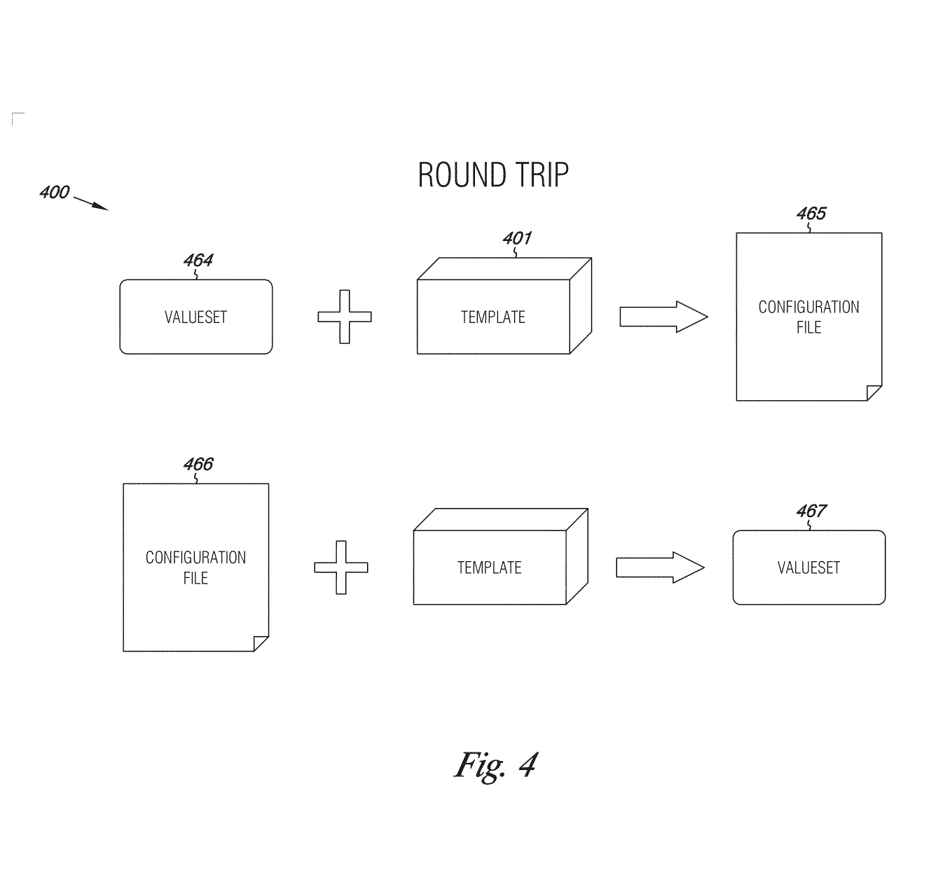

FIG. 4 is a drawing illustrating an embodiment of using a configuration file template. FIG. 4 illustrates a roundtrip method 400 for beginning with a value set 464 and using a configuration file template 401 to create a configuration file 465. The user can also begin with a configuration file 466 and using a configuration template 401 create a value set 467. The value set can include the parameters associated with each syntax element or group of syntax elements selected by the user.

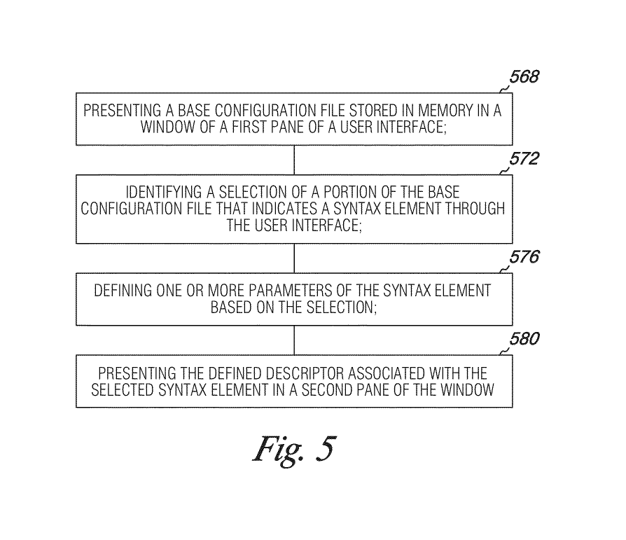

FIG. 5 is a block diagram illustrating a method for creating a configuration file template according to one or more embodiments. FIG. 5 illustrates a method 500 for creating a configuration file template according to one or more embodiments of the present disclosure. Embodiments of the present disclosure are not limited to the steps illustrated in FIG. 5.

The presenting a base configuration file, stored in memory, to create configuration file template in a window of a first read-only pane of a user interface 568. In an embodiment, the method includes selecting a portion of the base configuration file that indicates a syntax element through the user interface 572 and defining one or more parameters of the syntax element in a syntax editing pane of the window 576 and presenting the defined descriptor associated with the selected syntax element in a second read-only pane of the window 580.

In an embodiment the method includes defining one of the parameters with the name of the value in a key-value pair as the defined descriptor. In another embodiment, the defined descriptor presented in the second read-only pane is identified by an “@” symbol immediately preceding and following the descriptor. One example method allows the user to select more than one defined descriptor through the user interface, and the syntax element or group of syntax elements associated with each of the user defined descriptors is presented as visually distinct from syntax elements associated with other user defined descriptors in the first read-only pane. In an arrangement the visual distinction is presented as highlighting. In an embodiment the method includes selecting a user defined descriptor in the second read-only pane and editing one or more of the parameters in a syntax editing pane.

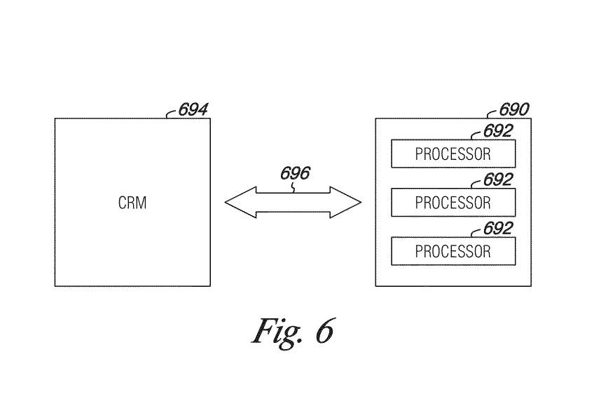

FIG. 6 illustrates a block diagram of an example of a computer readable medium (CRM) 694 in communication with processing resources 690. As used herein, processor resources 690 can include one or a plurality of processors 692 such as in a parallel processing arrangement. A computing device having processor resources can be in communication with, and/or receive a tangible non-transitory computer readable medium (CRM) 694 storing a set of computer readable instructions (e.g., software) for capturing and/or replaying network traffic, as described herein.

As used herein, the indefinite articles “a” and/or “an” can indicate one or more than one of the named object. Thus, for example, “a processor” can include one processor or more than one processor. Processor resources can also be control circuitry that can have a structure that provides a given functionality, and/or execute computer-readable instructions that are stored on an internal or external non-transitory computer-readable medium. Non-transitory computer-readable medium (e.g., computer readable medium 694), as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, EEPROM, phase change random access memory (PCRAM), magnetic memory such as a hard disk, tape drives, floppy disk, and/or tape memory, optical discs, digital video discs (DVD), high definition digital versatile discs (HD DVD), compact discs (CD), and/or a solid state drive (SSD), flash memory, etc., as well as other types of machine-readable media.

The non-transitory computer-readable medium can be integral, or communicatively coupled, to a computing device, in either in a wired or wireless manner. For example, the non-transitory computer-readable medium can be an internal memory, a portable memory, a portable disk, or a memory located internal to another computing resource (e.g., enabling the computer-readable instructions to be downloaded over the Internet). The non-transitory computer-readable medium can have computer-readable instructions stored thereon that are executed by the processing resources (e.g., control circuitry, processor(s)) to provide a particular functionality.

The CRM 694 can be in communication with the processor 690 resources via a communication path 696. The communication path 696 can be local or remote to a machine associated with the processor resources 690. Examples of a local communication path 696 can include an electronic bus internal to a machine such as a computer where the CRM 694 is one of volatile, non-volatile, fixed, and/or removable storage medium in communication with the processor resources 690 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

In other examples, the communication path 696 can be such that the CRM 464 is remote from the processor resources 690 such as in the example of a network connection between the CRM 694 and the processor resources 690 (e.g., the communication path 696 can be a network connection). Examples of such a network connection can include a local area network (LAN), a wide area network (WAN), a personal area network (PAN), the Internet, among others. In such examples, the CRM 694 may be associated with a first computing device (e.g., a server) and the processor resources 690 may be associated with a second computing device (e.g., a client). The first and second computers can be in communication via a networked communication path 696.

Logic can be used to implement the method(s) of the present disclosure, in whole or part. Logic can be implemented using appropriately configured hardware and/or software. For example computers creating a configuration file template can include logic configured to present a base configuration file stored in memory in a window of a first pane of a user interface, identify a selection of a portion of the base configuration file that indicates a syntax element, define one or more parameters of the syntax element based on the selection, and present the defined descriptor associated with the selected syntax element in a second pane of the window. The above-mention logic portions may be discretely implemented and/or implemented in a common arrangement.

As used herein, the term “read-only” refers to a pane where contents of pane cannot be modified directly by the user. Read-only allows for user selectability by various methods, including highlighting displayed character elements.

Although specific embodiments have been illustrated and described herein, it will be appreciated that an arrangement calculated to achieve the same results can be substituted for the specific embodiments shown. This disclosure is intended to cover adaptations or variations of one or more embodiments of the present disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the one or more embodiments of the present disclosure includes other applications in which the above structures and methods are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim.

Rather, as the flowing claims reflect, inventive subject matter lies in less than all features of a single disclosed embodiment. Thus, the following claims are hereby incorporated into the Detailed Description, with each claim standing on its own as a separate embodiment.

What is claimed:

1. A method for creating a configuration file template, comprising:
presenting a base configuration file stored in memory in a window 290 of a first pane 220 of a user interface 200/568;
identifying a selection of a portion of the base configuration file that indicates a syntax element 236 through the user interface 236/572;
defining 240/242/244 one or more parameters 230/232/234 of the syntax element based on the selection 244/576;
wherein the one or more parameters are defined upon receiving a value 244 or choosing from an already defined list of values 242;
wherein at least one of the parameters 230 includes a defined descriptor 240 for the selected syntax element 236; and
presenting the defined descriptor 246 associated with the selected syntax element 236 in a second pane 222 of the window 290/580.

2. The method of claim 1, wherein the first pane 220 is a read-only pane and the second pane 222 is a read-only pane.

3. The method of claim 1 wherein the defined descriptor presented in the second pane is identified by an “@” symbol immediately preceding and following the defined descriptor 246/248.

4. The method of claim 1 wherein a selection of more than one defined descriptor is identified in the second pane 222 and the syntax element 236 or group of syntax elements associated with each user defined descriptor 246 is made to stand out visually from syntax elements associated with other defined descriptors 236 in the first pane 220.

5. The method of claim 1, wherein the defined descriptor 248 presented in the second pane 222 replaces multiple syntax elements 227/228 from the first pane 220.

6. The method of claim 1 wherein selection of a defined descriptor is identified in the second pane 246/222 and the user edits 240/242/244 one or more of the parameters 230/232/234 of the defined descriptor in a syntax editing pane 224 in the window 290.

7. The method of claim 1 wherein a selection identifies a user defined descriptor 246 in the second pane 222 and the syntax element or group of syntax elements associated with the defined descriptor is made to stand out visually 236 from surrounding text via highlighting in the first pane 220.

8. A computer-readable non-transitory medium storing a set of instructions executable by a processor to:
present a base configuration file stored in memory as a starting point for a template in a first read-only pane 220 and in a second read-only pane 222 in a window 290 in a user interface 200;
identify a selection of an element from the base configuration file 236;
define 240/242/244 one or more parameters 230-235/237-239 of the element based on the selection;
wherein one or more parameters are defined upon receiving a value 234 or choosing from an already defined list of values 242; and
wherein at least one of the parameters includes a defined descriptor 230/240 for the selected element or group of elements 236; and
modify the second read-only pane 222 to replace the element from the base configuration file 236 with the defined descriptor 246.

9. The computer-readable medium of claim 8, further comprising instructions to:
select the defined descriptor 246 in the second read-only pane 224 through the user interface; and
present the element associated the defined descriptor in a visually distinct manner 236 from the remainder of the base configuration file in the first read-only pane 220.

10. The computer-readable medium of claim 8, further comprising instructions to:
select multiple defined descriptors in the second read-only pane 222 through the user interface; and
present the syntax elements associated with each defined descriptor in a visually distinct manner 236 from the remainder of the base configuration file in the first read-only pane 220.

11. The computer-readable medium of claim 8, further comprising instructions to:
present the defined descriptor 246 in the second read-only pane 222 with the same text character immediately preceding and following the defined descriptor.

12. The computer-readable medium of claim 8, further comprising instructions to:
select a defined descriptor 246 in the second read-only pane 222 and edit 240/242/244 a number of the parameters 230/232/234 of the defined descriptor 246 in the syntax editing pane 224 in the window 290.

13. A system for creating a configuration file template, comprising:
logic configured 696 to present a base configuration file stored in to create a configuration file template in a window 290 of a first read-only pane 220 in a user interface 200;
logic configured 696 to identify a selection a portion of the base configuration file that indicates a syntax element or group of elements 236 through the user interface;
logic configured 696 to define 240/242/244 one or more parameters 230-235/237-239 of the syntax based on the selection;
wherein one or more parameters are defined upon receiving a value 244 or choosing from an already defined list of values 242; and
wherein at least one of the parameters 230 includes a defined descriptor 240 for the selected syntax element; and
wherein the syntax element models a value identifiable by a configuration parser 319; and
logic configured to present the defined descriptor 246 associated with the selected syntax element or group of elements in the window of a second read-only pane 222; and
logic configured to present highlighted 236 the syntax element or group of elements associated with the defined descriptor 246 in the first read-only pane 220.

14. The system of claim 13, further comprising logic to identify selection of the defined descriptor 246 in the second read-only pane 222 through the user interface by making the defined descriptor visually distinct 246 from the surrounding text.

15. The system of claim 13 wherein logic is configured to define 240/242/244 one or more parameters 230/232/234 of the syntax based on information input by a user in a syntax editing pane 224.
